(19) United States
(12) Patent Application Publication
(10) Pub. No.: US 2025/0092880 A1
(43) Pub. Date: Mar. 20, 2025

(54) CASING ASSEMBLY, ELECTRIC FAN, AND FLOOR SCRUBBER

(71) Applicant: GUANGDONG WELLING MOTOR MANUFACTURING CO., LTD., Foshan (CN)

(72) Inventors: An'an CHEN, Foshan (CN); Xiaowei WANG, Foshan (CN); Meijian XIONG, Foshan (CN); Zhengzhong QIAO, Foshan (CN)

(73) Assignee: GUANGDONG WELLING MOTOR MANUFACTURING CO., LTD., Foshan (CN)

(21) Appl. No.: 18/963,904

(22) Filed: Nov. 29, 2024

Related U.S. Application Data
(63) Continuation of application No. PCT/CN2023/082539, filed on Mar. 20, 2023.

(30) Foreign Application Priority Data
Jun. 1, 2022 (CN) 202210629296.8

(51) Int. Cl. F04D 29/40; A47L 11/40; F04D 29/08

(52) U.S. Cl. CPC F04D 29/403; F04D 29/083; A47L 11/40

(57) ABSTRACT

A casing assembly, an electric fan, and a floor scrubber are provided. The casing assembly includes a housing and a cover plate. The housing has an open end. The cover plate has an assembly end connected to the open end. One of the open end and the assembly end is provided with an elastic sealing part, and the other is provided with a fitting part. A first annular projection and a second annular projection are arranged between the elastic sealing part and the fitting part. The first annular projection is located on an inner side of the second annular projection, or vice versa, in the radial direction of the open end. Two ends of the first annular projection abut against the elastic sealing part and the fitting part, respectively. Two ends of the second annular projection abut against the elastic sealing part and the fitting part, respectively.

### CROSS-REFERENCE TO RELATED APPLICATIONS

This application is a continuation of International Application No. PCT/CN2023/082539 filed on Mar. 20, 2023, which claims priority to Chinese Patent Application No. 202210629296.8, filed on Jun. 1, 2022, and entitled “CASING ASSEMBLY, ELECTRIC FAN AND FLOOR SCRUBBER”, the entire contents of which are incorporated here by reference for all purposes. No new matter has been introduced.

### FIELD

The present disclosure relates to the field of floor scrubbers, and in particular to a casing assembly, an electric fan, and a floor scrubber.

### BACKGROUND

As people's lives becomes increasingly intelligent, the application of floor scrubbers capable of conducting the floor cleaning work becomes more and more popular. In the related art, a floor scrubber can suck water or other impurities on the floor, and the air is driven by an electric fan to flow, so as to dry and clean the floor. However, the housing structure of the conventional electric fan has an unsatisfactory sealing effect, such that when the floor scrubber operates, some water or impurities can enter the interior of the electric fan, resulting in burning of an internal circuit of the electric fan, and deterioration the service life of the floor scrubber.

### SUMMARY

The present disclosure aims to solve at least one of the problems existing in the existing technology. To this end, the present disclosure proposes a housing assembly, an electric fan with the housing assembly, and a floor scrubber with the electric fan.

According to a first aspect of the present disclosure, an embodiment provides a housing assembly, comprising a housing and a cover plate, where the housing is provided with an open end, and the cover plate is provided with an assembly end, which is connected with the open end. One of the open end and the assembly end is provided with an elastic sealing part, the other one is provided with a fitting part. A first annular projection and a second annular projection are arranged between the fitting part and the elastic sealing part. The second annular projection is located at an inner side of the first annular projection along a radial direction of the open end. Two ends of the first annular projection abut against the elastic sealing part and the fitting part, respectively, and two ends of the second annular projection abut against the elastic sealing part and the fitting part, respectively.

According to some embodiments of the present disclosure, the first annular projection is arranged at the fitting part, the second annular projection is arranged at the elastic sealing part. The first annular projection abuts against the elastic sealing part, and the second annular projection abuts against the fitting part.

According to some embodiments of the present disclosure, the first annular projection and the second annular projection are coaxially arranged.

According to some embodiments of the present disclosure, an interval between the first annular projection and the second annular projection along the radial direction of the open end is L, which satisfies: 0≤L≤0.5 mm.

According to some embodiments of the present disclosure, a height difference between a height of the first annular projection and a height of the second annular projection along an axial direction of the open end is S, which satisfies: 0.1 mm≤S≤0.3 mm.

According to some embodiments of the present disclosure, the height of the first annular projection along the axial direction of the open end is H, which satisfies: 0.4 mm≤H≤0.8 mm.

According to some embodiments of the present disclosure, the second annular projection has a cross section of one of a semicircular shape, a trapezoidal shape, and a square shape.

According to some embodiments of the present disclosure, the elastic sealing part is arranged at an end of the cover plate facing the housing, and the fitting part is arranged at an end of the housing facing the cover plate.

According to some embodiments of the present disclosure, the elastic sealing part is a rubber member or a silicone member, and wraps one end of the cover plate.

According to some embodiments of the present disclosure, the housing is provided with a first connecting hole, the cover plate is provided with a second connecting hole. The cover plate is connected to the housing by inserting fasteners through the first connecting hole and the second connecting hole.

According to some embodiments of the present disclosure, the housing further comprises a plurality of connecting plates. The plurality of connecting plates is arranged at intervals along a circumferential direction of the open end and each of which is provided with a first connecting hole.

According to a second aspect of the present disclosure, an embodiment provides an electric fan, including the housing assembly according to the embodiment of the first aspect.

According to a third aspect of the present disclosure, an embodiment provides a floor scrubber, including the electric fan according to the embodiment of the second aspect.

Additional aspects and advantages of the present disclosure will be partially set forth in and partially apparent from the description below or understood through practice of the present disclosure.

### BRIEF DESCRIPTION OF DRAWINGS

The present disclosure will be further described below in conjunction with the accompanying drawings and embodiments, and in the drawings:

FIG. 1 is a schematic structural diagram of a housing assembly according to an embodiment of the present disclosure;

FIG. 2 is a sectional view of the housing assembly according to an embodiment of the present disclosure;

FIG. 3 is an enlarged view of portion A shown in FIG. 2;

FIG. 4 is a sectional view of a housing of the housing assembly according to the embodiment of the present disclosure;

FIG. 5 is an enlarged view of portion B shown in FIG. 4;

FIG. 6 is a side view of the housing of the housing assembly according to the embodiment of the present disclosure;

FIG. 7 is a sectional view of a cover plate of the housing assembly according to the embodiment of the present disclosure;

FIG. 8 is an enlarged view of portion C shown in FIG. 7;

FIG. 9 is a side view of the cover plate of the housing assembly according to the embodiment of the present disclosure; and

FIG. 10 is a schematic structural diagram of a floor scrubber according to an embodiment of the present disclosure.

Reference numerals are provided as follows:
housing 100; open end 110; fitting part 111; first annular projection 112; connecting plate 120; first connecting hole 121;
cover plate 200; assembly end 210; elastic sealing part 211; second annular projection 212; second connecting hole 220;
floor scrubber 300; hand-held part 310; connecting rod 320; electric fan 330; cleaning part 340.

### DETAILED DESCRIPTION OF EMBODIMENTS

Embodiments of the present disclosure will be described in detail hereinafter with reference to accompanying drawings in which the same or like reference numerals refer to the same or like elements or elements having the same or like functions throughout. The embodiments described below with reference to the accompanying drawings are exemplary and are intended for illustration only and are not to be construed as limiting the present disclosure.

In the description of the present disclosure, it should be understood that for the description of orientations, the orientation or positional relationships indicated by the terms such as “on”, “below”, “front”, “rear”, “left”, and “right” are based on orientation or position relationships shown in the accompanying drawings, and are used only for ease and brevity of illustration and description, rather than indicating or implying that the mentioned apparatus or element must have a particular orientation or must be constructed and operated in a particular orientation. Therefore, such terms should not be construed as limiting of the present disclosure.

It should be understood that in the description of the embodiments of the present disclosure, the term “at least one” means one or more, the term “a plurality of” means two or more, the term such as “greater than”, “less than”, “exceed” or variants thereof prior to a number or series of numbers is understood to not include the number adjacent to the term. The term “above”, “below”, “within” prior to a number or series of numbers is understood to include the number adjacent to the term. If used herein, the terms such as “first”, “second”, and the like are merely used for distinguishing technical features, and are not intended to indicate or imply relative importance, or implicitly point out the number of the indicated technical features, or implicitly point out the precedence order of the indicated technical features.

In the description of the present disclosure, unless otherwise explicitly defined, the terms such as “configure”, “mount” and “connect” should be understood in a broad sense, and those having ordinary skills in the art can reasonably determine the specific meanings of the above terms in the present disclosure based on the specific contents of the technical scheme.

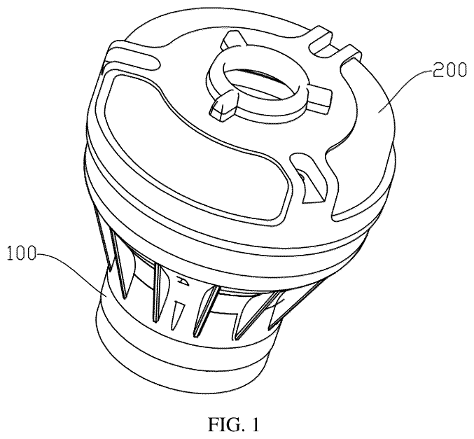

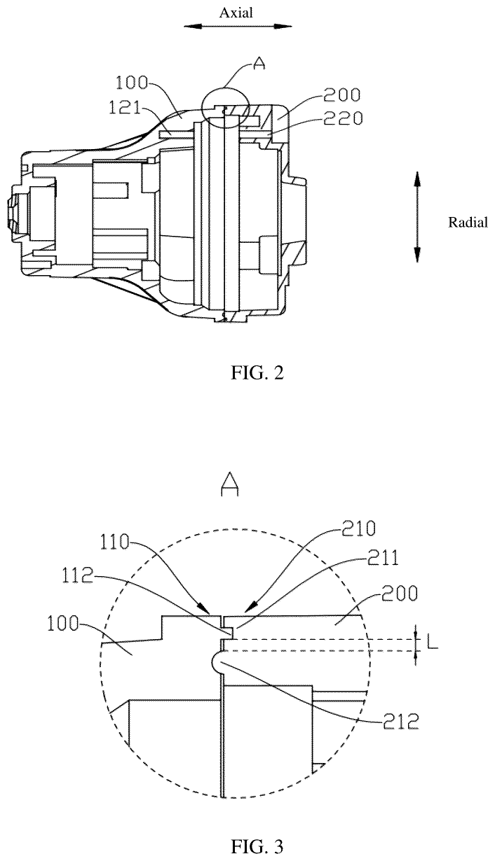

Referring to FIG. 1, in an embodiment of a first aspect of the present disclosure, a housing assembly includes a housing 100 and a cover plate 200. Referring to FIG. 2 and FIG. 3, the housing 100 is provided with an open end 110, the cover plate 200 is provided with an assembly end 210, and the assembly end 210 of the cover plate 200 is connected to the open end 110 of the housing 100. The assembly end 210 of the cover plate 200 is provided with an elastic sealing part 211, and the open end 110 of the housing 100 is provided with a fitting part 111. A first annular projection 112 and a second annular projection 212 are arranged between the elastic sealing part 211 and the fitting part 111. The second annular projection 212 is located at an inner side or an outer side of the first annular projection 112 along a radial direction of the open end 110. After the cover plate 200 is assembled with the housing 100, two ends of the first annular projection 112 abut against the elastic sealing part 211 and the fitting part 111, respectively, and two ends of the second annular projection 212 abut against the elastic sealing part 211 and the fitting part 111, respectively, such that the housing assembly is provided with two layers of sealing structures, improving the sealing performance of the housing assembly.

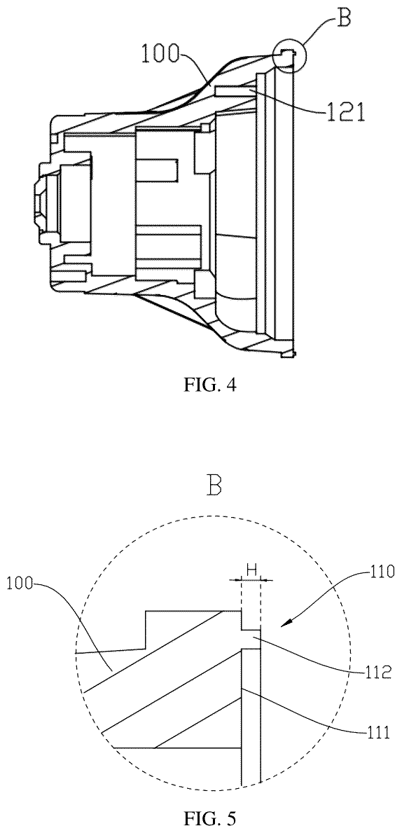

Referring to FIG. 4 and FIG. 5, in some embodiments of the present disclosure, the first annular projection 112 is integrally formed with the fitting part 111, that is, the fitting part 111 is provided with the first annular projection 112 facing the elastic sealing part 211; and the second annular projection 212 is integrally formed with the elastic sealing part 211, that is, the elastic sealing part 211 is provided with the second annular projection 212 facing the fitting part 111. The first annular projection 112 is located at an inner side of the second annular projection 212, or the second annular projection 212 is located at an inner side of the first annular projection 112, that is, there is an interval between the first annular projection 112 and the second annular projection 212. When the cover plate 200 is connected to the housing 100, the first annular projection 112 abuts against the elastic sealing part 211 to form a first layer of sealing structure, and the second annular projection 212 abuts against the fitting part 111 to form a second layer of sealing structure. Thus, the first annular projection 112 and the second annular projection 212 form a dual sealing structure together, which improves the sealing performance of the housing assembly to effectively prevent water, dust or other impurities from entering the housing assembly, circuit components inside the housing assembly are protected.

It should also be noted that both the first annular projection 112 and the second annular projection 212 may be arranged at the fitting part 111, and abut against the elastic sealing part 211. Alternatively, both the first annular projection 112 and the second annular projection 212 may be arranged at the elastic sealing part 211, and abut against the fitting part 111. This may be determined according to actual conditions, and is not specifically limited herein.

It should be noted that the elastic sealing part 211 may also be arranged at the open end 110 of the housing 100 and is provided with the second annular projection 212, and the fitting part 111 may be arranged at the assembly end 210 of the cover plate 200, and is provided with the first annular projection 112. As long as the dual sealing structure can be formed to improve the sealing performance of the housing assembly, the specific structure may be selected according to actual conditions, which is not specifically limited herein. That is, the elastic sealing part 211 is arranged at the open end 110 of the housing 100, and the fitting part 111 is arranged at the assembly end 210 of the cover plate 200. Alternatively, the elastic sealing part 211 is arranged at the assembly end 210 of the cover plate 200, and the fitting part 111 is arranged at the open end 110 of the housing 100. It should also be noted that the open end 110 of the housing 100 is provided with a through hole, and the sidewall of the through hole constructs as the fitting part 111 or the elastic sealing part 211, such that impurities, such as water or dust, can be prevented from entering the through hole by the dual sealing structure.

In some embodiments of the present disclosure, an end of the cover plate 200 facing the housing 100 is the assembly end 210, and the elastic sealing part 211 is arranged at the assembly end 210 of the cover plate 200. An end of the housing 100 facing the cover plate 200 is the open end 110, and the fitting part 111 is arranged at the open end 110. It should be noted that the elastic sealing part 211 is made of a material with elasticity and sealing property, such as a rubber member or a silicone member, that is, the assembly end 210 of the cover plate 200 is wrapped by the sealing material, such as the rubber member or the silicone member, thus forming the elastic sealing part 211. It can be understood that the second annular projection 212 is made of the same material as the elastic sealing part 211, and may be integrally formed with the elastic sealing part 211, so as to facilitate the manufacturing and mounting of the housing assembly.

It should also be noted that the cover plate 200 is a plastic-rubber insert. The end of the cover plate 200 facing the housing 100 is the assembly end 210, and the rubber member is inserted in the assembly end 210 to form the elastic sealing part 211, which is provided with the second annular projection 212. The housing 100 is made of a metal material, such as aluminum casting, or plastic. The end of the housing 100 facing the cover plate 200 is provided with the fitting part 111, and the fitting part 111 is provided with the first annular projection 112 to mate with the elastic sealing part 211, such that the dual sealing structure of the housing assembly is formed. Alternatively, the housing 100 is a plastic-rubber insert, and the rubber member is inserted in the end of the housing 100 facing the cover plate 200 to form the elastic sealing part 211, and the end of the cover plate 200 facing the housing 100 is provided with the fitting part 111.

In some embodiments of the present disclosure, when the cover plate 200 is connected to the housing 100, the second annular projection 212 is located at an inner side of the first annular projection 112. The first annular projection 112 is made of a hard material, such as a metal piece, such as aluminum casting, or a plastic piece. When the cover plate 200 is connected to the housing 100 and the second annular projection 212 abuts against the fitting part 111, the second annular projection 212 is pressed to deform, thus pressing the elastic sealing part 211 to deform, such that the elastic sealing part 211 tends to extend to an outer side of the housing assembly. Therefore, the second annular projection 212 is located at an inner side of the first annular projection 112, and the first annular projection 112 can effectively prevent the elastic sealing part 211 from protruding out of the housing assembly to affect the appearance and the mounting of other components. Therefore, the first annular projection 112 abutting against the elastic sealing part 211 not only plays a sealing role, but also effectively prevents the elastic sealing part from being pressed to deform and protrude outward.

In some embodiments of the present disclosure, the open end 110 of the housing 100 is made a sleeve shape, the fitting part 111 is an end face of the open end 110, and the first annular projection 112 is arranged along a circumferential direction of the end face, thus forming an annular structure. The assembly end 210 of the cover plate 200 is also made a sleeve shape and matched with the open end 110 of the housing 100. The second annular projection 212 is arranged along a circumferential direction of the elastic sealing part 211, thus forming an annular structure. The cover plate 200 is connected to the housing 100, the second annular projection 212 abuts against the fitting part 111, the first annular projection 112 abuts against the elastic sealing part 211, and the first annular projection 112 and the second annular projection 212 are coaxially arranged. Therefore, along the radial direction of the open end 110, the first annular projection 112 is equally distanced from the second annular projection 212, improving the sealing performance of the dual sealing structure, and the cover plate 200 is more stably connected to the housing 100.

It should be noted that the open end 110 of the housing 100 may also have other shapes, such as a square shape, and the assembly end 210 of the cover plate 200 is formed into a shape matched with that of the open end 110. The fitting part 111 is the end face of the open end 110, and a projection is arranged around the end face to form the first annular projection 112. The assembly end 210 of the cover plate 200 also has a square shape matched with that of the open end 110 of the housing 100, and a projection is arranged around the elastic sealing part 211, to form the second annular projection 212. The cover plate 200 is connected to the housing 100, the second annular projection 212 abuts against the fitting part 111, the first annular projection 112 abuts against the elastic sealing part 211, and the first annular projection 112 and the second annular projection 212 are coaxially arranged. Therefore, the first annular projection 112 is equally distanced from the second annular projection, such that the cover plate 200 is more stably connected to the housing 100 with a better sealing performance.

In some embodiments of the present disclosure, referring to FIG. 3, along the radial direction of the open end 110 of the housing 100, the interval between the first annular projection 112 and the second annular projection 212 is L, where L satisfies: 0≤L≤0.5 mm (for example, the value of L may be 0.1 mm, 0.2 mm, or 0.5 mm). When L=0, the first annular projection 112 and the second annular projection 212 come into contact to realize the sealing between the housing 100 and the cover plate 200. When L>0, there may be a certain interval between the first annular projection 112 and the second annular projection 212, to reduce mutual influence therebetween, and further facilitate improvement of the sealing effect. The value of L value may be appropriately selected according to actual conditions, which is not specifically limited herein. Since the open end usually has a small width along the radial direction, the value of L should not be too large to cause the second annular projection 212 to be too close to an inner sidewall of the open end 110. In this way, the second annular projection 212 can be prevented from being pressed to deform to extend into the interior of the housing 100 and affect the components in the housing.

In some embodiments of the present disclosure, referring to FIG. 5, along the axial direction of the open end 110, the first annular projection 112 has a height of H, where H satisfies: 0.4 mm≤H≤0.8 mm (for example, the value of H may be 0.4 mm, 0.6 mm or 0.8 mm). The value of H may be appropriately selected according to actual conditions, which is not specifically limited here. By setting an appropriate height H of the first annular projection 112, it can be ensured that the elastic sealing part 211 is deformed to a certain degree to have a satisfactory sealing effect. It should be avoided that the value of the height H of the first annular projection 112 is too large to affect the assembly of the cover plate 200 and the housing 100, or that the value of the height H of the first annular projection 112 is too small to make the sealing effect unsatisfactory. That is, when the first annular projection 112 abuts against the elastic sealing part 211, the elastic sealing part 211 will be elastically deformed, such that the elastic sealing part 211 can have more areas contacted with surfaces of the first annular projection 112, thus achieving a better sealing effect.

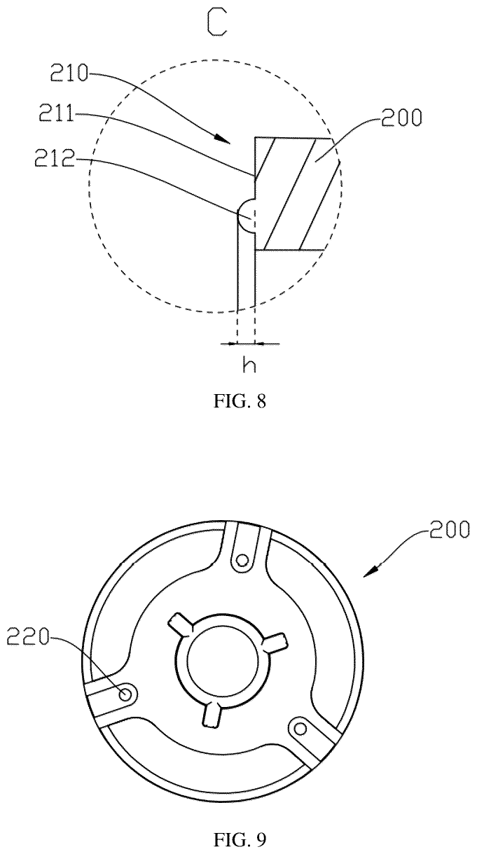

In some embodiments of the present disclosure, referring to FIGS. 5 to 8, along the axial direction of the open end 110, a height difference between the height of the first annular projection 112 and the height of the second annular projection 212 is S, where S=|H−h|, i.e., an absolute value of the height H of the first annular projection 112 minus the height h of the second annular projection 212, where S satisfies: 0.1 mm≤S≤0.3 mm (for example, the value of S may be 0.1 mm, 0.2 mm or 0.3 mm). The value of S may be appropriately selected according to actual conditions, which is not specifically limited herein. It should be noted that by setting an appropriate height difference, the sealing effect is better when the first annular projection 112 abuts against the elastic sealing part 211 and the second annular projection 212 abuts against the fitting part 111, and the problem that the sealing effect is reduced due to excessive height difference can be avoided. It should be noted that if the height difference between the first annular projection 112 and the second annular projection 212 is too large (that is, the first annular projection 112 is too high), when the first annular projection 112 abuts against the elastic sealing part 211, the elastic sealing part 211 will be pushed up too much, such that the second annular projection 212 cannot come into full contact with the fitting part 111, thus affecting the sealing performance; or if the height of the second annular projection 212 is too large, when the second annular projection 212 abuts against the fitting part 111, the first annular projection 112 cannot fully abut against the elastic sealing part 211, resulting in a unsatisfactory sealing effect when the first annular projection 112 mates with the elastic sealing part 211.

It can be understood that the interval L between the first annular projection 112 and the second annular projection 212, the height difference S between the first annular projection 112 and the second annular projection 212, and the height H of the first annular projection 112 are correlated with one another. The values of L, S and H may affect one another. For example, a larger interval L between the first annular projection 112 and the second annular projection 212 may allow the value range of the height difference S between the first annular projection 112 and the second annular projection 212 and the value range of the height H of the first annular projection 112 to be expanded. It should be noted that the specific values of L, S and H may be determined according to actual conditions as long as a satisfactory sealing effect of the dual sealing structure of the housing assembly can be ensured, which are not particularly limited herein.

It should also be noted that there is also a certain distance between the first annular projection 112 and the outermost side of the fitting part 111. The first annular projection 112 abuts against the elastic sealing part 211, and a gap between the first annular projection 112 and the outermost side of the fitting part 111 may serve as an avoidance space, such that the elastic sealing part 211 can wrap multiple surfaces of the first annular projection 112 to improve the sealing performance. Moreover, by reserving a certain avoidance space, the elastic sealing part 211 can be prevented from extending to the outer side of the housing assembly due to elastic deformation to affect the appearance or the mounting of other components.

In some embodiments of the present disclosure, the second annular projection 212 may have a cross section of a semicircular, trapezoidal, square or triangular shape, etc., or a combination thereof. For example, a side of the cross section of the second annular projection 212 facing the fitting part 111 is semicircular, with the arc surface facing the fitting part, while a side of the cross section of the second annular projection 212 away from the fitting part 111 is square, with one side of the square being coincident with the diameter of the semicircle. That is, if the cross section of the second annular projection 212 is semicircular, the side of the second annular projection 212 facing the fitting part 111 is an arc-shaped curved surface. Therefore, when the second annular projection 212 abuts against the fitting part 111, the contact area is larger, resulting in stable abutment and a better sealing effect. The cross section of the first annular projection 112 may also have other special shapes, which may be determined according to specific conditions and are not specifically limited herein.

In some embodiments of the present disclosure, the structure of the first annular projection 112 is similar to that of the second annular projection 212. That is, the cross section of the first annular projection 112 may also be of a semicircular, trapezoidal, square, or triangular shape, etc., or a combination thereof (for example, half semicircular and half square). If the cross section of the first annular projection 112 is rectangular, the first annular projection 112 has a cylindrical sleeve structure. The cross section of the first annular projection 112 may also have other special shapes, which may be determined according to specific conditions and are not specifically limited herein.

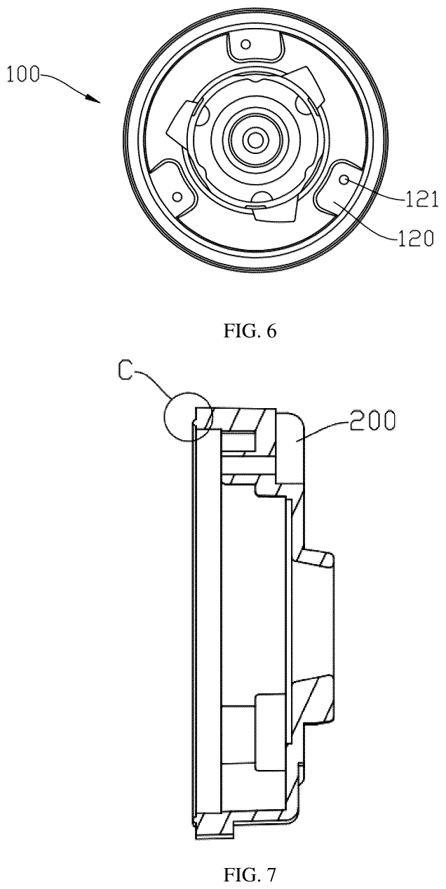

Referring to FIGS. 6 and 9, in some embodiments of the present disclosure, the housing 100 is provided with a first connecting hole, and the cover plate 200 is provided with a second connecting hole matched with the first connecting hole. That is, by inserting fasteners into the second connecting hole and the first connecting hole respectively, the cover plate 200 can be fixedly connected to the housing 100, and the assembly end 210 of the cover plate 200 can abut against the open end 110 of the housing 100, such that the fitting part 111 and the sealing part press against each other to form a sealing connection.

In some embodiments of the present disclosure, the housing 100 further includes a plurality of connecting plates 120, which are arranged at intervals along a circumferential direction of the open end 110 and each of which is provided with a first connecting hole 121 penetrating therethrough, the second connecting holes 220 are arranged corresponding to the first connecting hole 121, and by inserting the fasteners into the first connecting holes 121 and the second connecting holes 220 respectively, the cover plate 200 can be fixedly connected to the housing 100. Of course, other numbers (such as four, five or six) of connecting plates 120 may be arranged instead of three. The three connecting plates 120 are each provided with a first connecting hole 121 penetrating therethrough, the cover plate 200 is provided with the second connecting holes 220 at corresponding positions, and the cover plate 200 is connected to the housing 100 by inserting three fasteners (such as screws or bolts) into the corresponding first connecting holes 121 and second connecting holes 220, respectively.

It should be noted that the plurality of connecting plates 120 may be evenly arranged at intervals, such that the stress between the cover plate 200 and the housing 100 can be evenly distributed, to improve the mounting stability of the housing assembly. It should also be noted that the first connecting holes 121 and the second connecting holes 220 may also be through holes, and the cover plate 200 can be fixed to the housing 100 by fitting bolts into nuts. Alternatively, the first connecting holes 121 and the second connecting holes 220 may be screw holes, and the cover plate 200 can be fixed to the housing 100 by placing screws or bolts into the first connecting holes 121 and the second connecting holes 220.

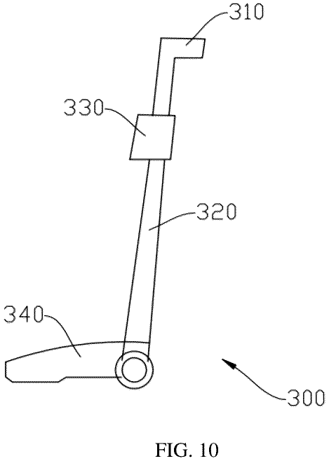

Referring to FIG. 10, an electric fan 330 according to an embodiment of a second aspect of the present disclosure is applied to a floor scrubber 300. The electric fan 330 includes the housing assembly according to the embodiment of the first aspect, which includes the housing 100 and the cover plate 200. The electric fan 330 further includes a driving assembly and a fan assembly. The driving assembly includes a stator, a rotor, a rotary shaft, etc., and is arranged in the housing 100. The fan assembly includes a fixed impeller, a movable impeller, a fan hood, etc., and is mounted on one side of the housing 100. The movable impeller is connected to the rotary shaft, and the rotary shaft can drive the movable impeller to rotate to generate airflow. Since the electric fan 330 adopts the housing assembly according to the embodiment of the first aspect, the sealing performance of the electric fan 330 can be improved by dual sealing. Thus, when the electric fan 330 is in use, water or other impurities can be prevented from entering the interior of the electric fan 330 to damage an internal circuit or precision parts, causing the damage and scrapping of the electric fan 330. Therefore, the service life of the electric fan 330 can be effectively prolonged by the housing assembly according to the embodiment of the first aspect. Of course, the electric fan 330 also includes at least all the beneficial effects of the housing assembly according to the embodiment of the first aspect, which will not be repeated herein. It should be noted that the housing assembly may also be applied to devices which require better sealing performance, such as motors.

The floor scrubber 300 according to the embodiment of the third aspect of the present disclosure includes the electric fan 330 according to the embodiment of the second aspect. The floor scrubber 300 adopts the electric fan 330 according to the embodiment of the second aspect. Since the electric fan 330 has satisfactory sealing performance, water or other impurities can be prevented from entering the interior of the electric fan 330, such that the internal circuit can be protected from being damaged. Thus, the service life of the electric fan 330 and thus the service life of the floor scrubber 300 can be effectively prolonged.

Referring to FIG. 10, the floor scrubber 300 further includes a hand-held part 310, a connecting rod 320, and a cleaning part 340. One end of the connecting rod 320 is connected to the hand-held part 310, and the other end of the connecting rod 320 is connected to the cleaning part 340. The cleaning part 340 is in contact with the floor for cleaning the floor. The electric fan 330 is mounted on the connecting rod 320. A user can hold the hand-held part 310 to push the floor scrubber 300, such that the cleaning part 340 can clean the floor. The electric fan 330 can generate airflow capable of meeting the cleaning requirement during operation, so as to meet the cleaning requirement of the user.

The floor scrubber 300 also includes at least all the beneficial effects of the housing assembly according to the embodiment of the first aspect and the electric fan 330 according to the embodiment of the second aspect, which will not be repeated herein. It should be noted that the electric fan 330 may also be applied to electrical cleaning appliances, such as sweepers and vacuum cleaners.

The embodiments of the present disclosure have been described with reference to the accompanying drawing in detail, but the present disclosure is not limited thereto, and various changes can be made within the knowledge of those having ordinary skills in the art without departing from the scope of the present disclosure.

What is claimed is:

1. A housing assembly comprising:
a housing provided with an open end; and
a cover plate provided with an assembly end, wherein the assembly end is connected to the open end;
wherein:
one of the open end and the assembly end is provided with an elastic sealing part, and the other one of the open end and the assembly end is provided with a fitting part;
a first annular projection and a second annular projection are arranged between the fitting part and the elastic sealing part;
the second annular projection is located at an inner side of the first annular projection along a radial direction of the open end;
two ends of the first annular projection abut against the elastic sealing part and the fitting part, respectively; and
two ends of the second annular projection abut against the elastic sealing part and the fitting part, respectively.

2. The housing assembly of claim 1, wherein:
the first annular projection is arranged at the fitting part;
the second annular projection is arranged at the elastic sealing part;
the first annular projection abuts against the elastic sealing part; and
the second annular projection abuts against the fitting part.

3. The housing assembly of claim 2, wherein the first annular projection and the second annular projection are coaxial.

4. The housing assembly of claim 2, wherein an interval between the first annular projection and the second annular projection along the radial direction of the open end is L, which satisfies: 0≤L≤0.5 mm.

5. The housing assembly of claim 2, wherein a height difference between a height of the first annular projection and a height of the second annular projection along an axial direction of the open end is S, which satisfies: 0.1 mm≤S≤0.3 mm.

6. The housing assembly of claim 2, wherein the height of the first annular projection along the axial direction of the open end is H, which satisfies: 0.4 mm≤H≤0.8 mm.

7. The housing assembly of claim 2, wherein the second annular projection has a cross section of a semicircular shape, a trapezoidal shape, or a square shape, or a combination thereof.

8. The housing assembly of claim 2, wherein the elastic sealing part is arranged at an end of the cover plate facing the housing, and the fitting part is arranged at an end of the housing facing the cover plate.

9. The housing assembly of claim 8, wherein the elastic sealing part comprises a rubber member or a silicone member, and wraps one end of the cover plate.

10. The housing assembly of claim 2, wherein:
the housing is provided with a first connecting hole;
the cover plate is provided with a second connecting hole; and
the cover plate is connected to the housing by inserting fasteners through the first connecting hole and the second connecting hole.

11. The housing assembly of claim 10, wherein:
the housing further comprises a plurality of connecting plates; and
the plurality of connecting plates are arranged at intervals along a circumferential direction of the open end and each of the plurality of connecting plates is provided with the first connecting hole.

12. An electric fan comprising the housing assembly of claim 1.

13. A floor scrubber comprising the electric fan of claim 12.
